(19) United States
(12) Patent Application Publication
(10) Pub. No.: US 2009/0288080 A1
(43) Pub. Date: Nov. 19, 2009

(54) Method of Delivering Software Over a Network

(76) Inventor: Lucas W. Partridge, Southampton (GB)

Correspondence Address: Dillon & Yudell LLP, 8911 N. Capital of Texas Hwy, Suite 2110, Austin, TX, 78759, US

(21) Appl. No.: 12/119,789

(22) Filed: May 13, 2008

(51) Int. Cl. G06F 9/445

(52) U.S. Cl. 717/178

(57) ABSTRACT

In a method of delivering software over a network a server presents a software feature selection list to a client. In response to selection of selected features from the software feature selection list, the server determines a set of software modules required to perform the selected features. The set of software modules includes a subset of core modules and a subset of non-core modules. The server begins downloading to the client machine the set of software modules. The client stores the core modules in core module storage as they are received. The client stores the non-core modules in non-core module storage as they are received. While the client is receiving and storing downloaded modules, the client determines if it has received the subset of core modules. The client examines a core module from the core module storage. If the client has installed all prerequisite modules for the examined core module, the client machine installs the examined core module; otherwise, the client examines another core module in the core module storage. The client continues to examine and install core modules until all of the core modules have been installed. After installing all of core modules, the client examines a non-core module from the non-core module storage. If the client has installed all prerequisite modules for the examined non-core module have been installed, the client installs the examined non-core module; otherwise, the client examines another non-core module to the non-core module storage. The client machine continues to examine and install non-core modules until all of the non-core modules have been installed.

### BACKGROUND OF THE INVENTION

1. Technical Field

The present invention relates in general to the field of delivery of software over a network, and more particularly to a method of downloading and installing a set of software modules determined according to features selected by a user.

2. Description of the Related Art

A popular method of acquiring software is over the Internet. Rather than going to a store to purchase, or ordering by mail, software stored on tangible media, a purchaser may go to a web site and purchase software for immediate download.

Ordering software over the Internet offers several advantages to the purchaser. It is much more convenient to order over the Internet than to go to a store. Also, purchasers like to be able to get the software when they want it rather than having to wait for it to arrive in the mail. However, there are some disadvantages to the current methods of purchasing software over the Internet. Most of the disadvantages stem from the fact that the purchaser must download the entire software application before beginning the installation process. For large applications and/or slow network connections, waiting for the download to complete can be tedious. Often, the user wants to install only a small subset of features of the application. Having to download the entire application takes time and valuable local storage space. If the network connection breaks during the download, the entire download may have to be restarted after reestablishing the connection.

### SUMMARY OF THE INVENTION

The present invention provides a method of delivering software over a network from a server machine to a client machine. The server machine presents a software feature selection list to the client machine. In response to selection of selected features from the software feature selection list, the server machine determines a set of software modules required to perform the selected features. The set of software modules includes a subset of core modules and a subset of non-core modules. The server machine begins downloading to the client machine the set of software modules. The client machine stores the core modules in core module storage as the core modules are received. The client machine stores the non-core modules in non-core module storage as the non-core modules are received. While the client machine is receiving and storing downloaded modules, the client machine determines if it has received the subset of core modules. When the client machine has received the subset of core modules, the client machine examines a core module from the core module storage. The client machine determines if all prerequisite modules for the examined core module have been installed on the client machine. If so, the client machine installs the examined core module; if not, the client machine examines another core module in the core module storage. The client machine continues to examine and install core modules until all of the core modules have been installed. After installing all of the core modules, the client machine examines a non-core module from the non-core module storage. The client machine determines if all prerequisite modules for the examined non-core module have been installed. If so, the client machine installs the examined non-core module; if not, the client machine examines another non-core module in the non-core module storage. The client machine continues to examine and install non-core modules until all of the non-core modules have been installed.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of an embodiment of a system according to the present invention;

FIG. 2 is a pictorial view of an embodiment of a software feature selection page according to the present invention;

FIG. 3 is an illustration of an embodiment of software modules according to the present invention;

FIG. 4 is a flow chart of an embodiment of server processing according to the present invention;

FIG. 5 is a flow chart of an embodiment of a client module receipt and storage processing according to the present invention; and,

FIG. 6 is a flow chart of an embodiment of a client module installation process according to the present invention.

### DETAILED DESCRIPTION OF THE PREFERRED EMBODIMENT

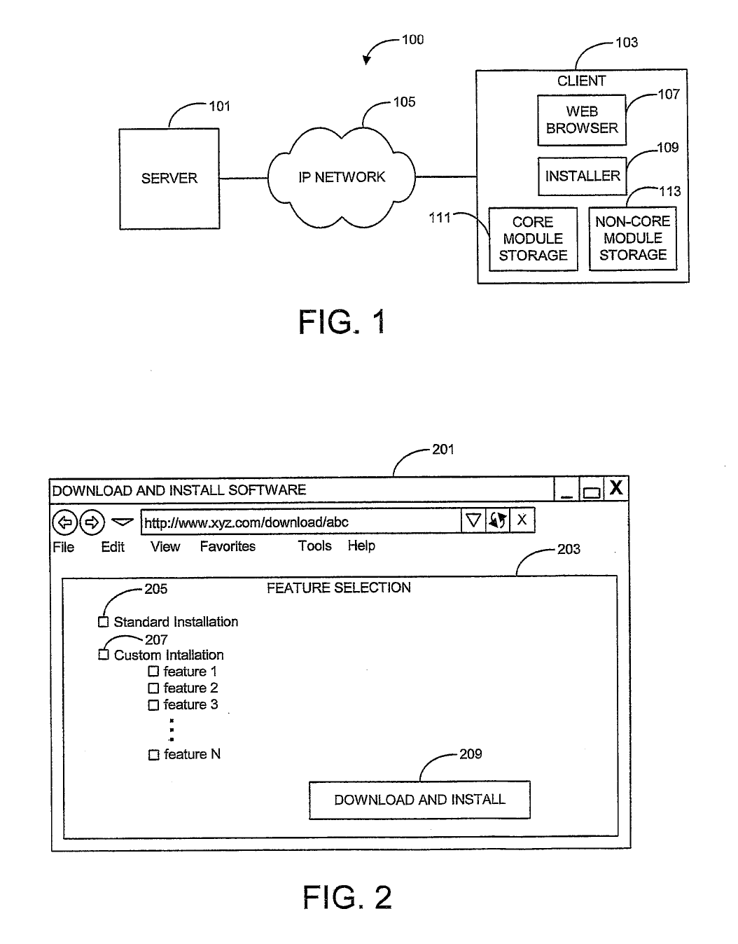

Referring now to drawings, and first to FIG. 1, an embodiment of a system according to the present invention is designated generally by the numeral 100. System 100 includes a server 101 and a client 103. Server 101 and client 103 may be any suitably programmed computers. Server 101 and client 103 are in communication with each other over an IP network 105, such as the Internet.

As will be explained in detail hereinafter, server 101 is adapted to serve web pages and download software to client 103. Client 103 includes a web browser 107 and a software installer component 109. Web browser 107 displays web pages served by server 101 and allows a user to interact with server 101. Software installer component 109 controls the installation of software downloaded from server 101. Client 103 includes temporary core module storage 111 and temporary non-core module storage 113. Installer component 109 stores software modules downloaded from server 101 in temporary storage 111 and 113 prior to installing the downloaded modules on client 103.

FIG. 2 illustrates an embodiment of a download and install software web page 201 according to the present invention. Web page 201 is served by server 101 and displayed by Web browser 107. Web page 201 includes a feature selection dialog 203. Feature selection dialog 203 includes a standard installation choice 205 and a custom installation choice 207. Choices 205 and 207 may be implemented using check boxes or other graphical controls. As will be explained in detail hereinafter, selection of standard installation choice 205 will cause server 101 to download to client 103 a standard set of software modules. If the user selects custom installation 207, the user must additionally select the specific features of the software to be installed. Server 101 will select and download to client 103 a set of software modules necessary to implement the selected features. After the user has selected either standard installation choice 205 or the features of custom installation choice 207, the user sends the selected choices to server 101 by clicking on a download and install button 209.

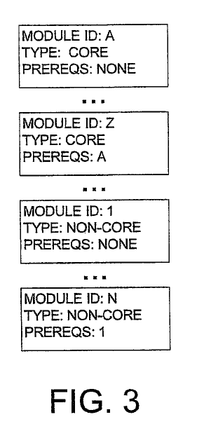

The software downloaded to client 103 from server 101 comprises a set of modules. As shown in FIG. 3, each module includes, in addition to the actual code, information that installer 109 of client 103 uses in connection with the installation of the software. The module information includes a module identifier, a modules type, and the list of prerequisite modules. The module identifier uniquely identifies the module. According to the present invention, a module may be either a core type module or a non-core type module. The core modules collectively represent the minimum subset of the software that must be received by the client before the install process can begin. Core modules are installed before any of the non-core modules. Prerequisite modules are modules that must be installed before installing a particular module.

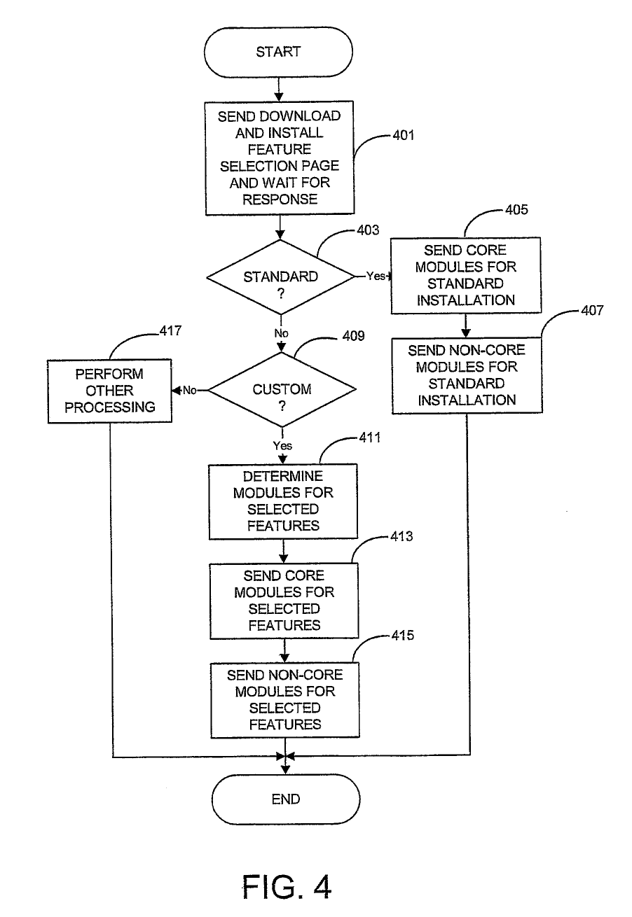

Referring to FIG. 4, there is illustrated a flow chart of an embodiment of server processing according to the present invention. The server sends a download and install feature selection page to the client and waits for a response, at block 401. If, as determined at decision block 403, the response is standard installation, the server sends the core modules for the standard installation, as indicated at block 405. Then, the server sends the non-core modules for the standard installation, at block 407. If, as determined at decision block 409, the response is a custom installation, the server determines, at block 411, the modules required for the selected custom installation features. The selection may be made with reference to a table or the like that maps features to modules. After selecting the appropriate modules, the server sends to the client the core modules for the selected features, as indicated at block 413. Then, the server sends the non-core modules for the selected features, as indicated at block 415. If, as determined at decision blocks 403 and 409, the response is neither standard nor custom, the server performs other processing, as indicated generally at block 417.

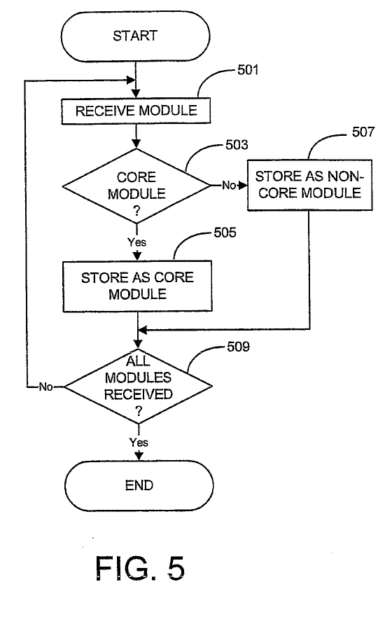

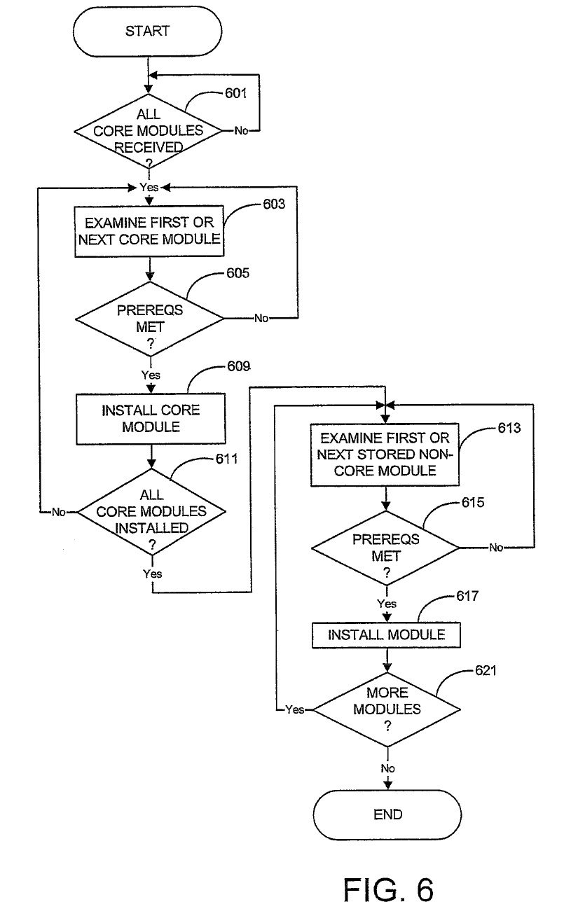

FIGS. 5 and 6 are flow charts of embodiments of client module receiving and installation processes, respectively. Preferably, the receiving and installation processes run simultaneously in a multitasking environment. Referring first to FIG. 5, the installer component 109 of client 103 receives a module, at block 501. If, as determined at decision block 503, the received module is a core module, the installer component stores the module in core module temporary storage, as indicated at block 505. If the received module is not a core module, the installer component stores the module in non-core module temporary storage, as indicated at block 507. After storing the received module, the installer component determines, at decision block 509, if all modules have been received. The determination may be made from a list, or the like, of modules to be downloaded, which may be sent from server 101 to client 103.

Referring to FIG. 6, the installation process waits until, as determined at decision block 601, all core modules have been received. Then, the installation process examines the first or next core module from core module temporary storage, at block 603. In one embodiment, the installation process examines the first or next core module by looking at its metadata. The metadata may be stored with the module or in a separate list. The installation process determines, at decision block 605, if all prerequisites to the installation of the examined module have been met. If not, processing returns to block If, as determined at decision block 605, the prerequisites have been met, the installation process installs the core module, as indicated at block 609. In some embodiments the installation of all core modules whose prerequisites have been met may be allowed to proceed concurrently. Then, the installation process determines, at decision block 611, if all core modules have been installed. If not, processing returns to block 603. Processing thus loops through blocks 603-611 until all core modules have installed. Since the processes of FIGS. 5 and 6 run independently, the installation process of FIG. 6 installs modules while the process of FIG. 5 receives and stores modules.

After installing all core modules, the installation process examines the first or next non-core module from temporary storage, at block 613. If, as determined at decision block 615, all prerequisites to the installation of the examined module have been met, the installation process installs the module, at block 617. If all prerequisites have not been met, processing returns to block 613. After installing a module, at block 617, the installation process determines, at decision block 621 if there are more modules. If so, processing returns to block 613. Thus, the installation process loops through blocks 613-621 until all non-core modules have been installed, at which point processing ends. In some embodiments the installation of all core modules whose prerequisites have been met may be allowed to proceed concurrently.

It should be apparent from the foregoing that maximum benefit will be obtained from this invention if the software is designed to have as few core modules as possible; ideally only one small module. Then, as soon as that has been received the installation process can begin whilst further, non-core modules are received in the background.

The list of modules to be received and installed is determined from a list of features selected by the user. In the present embodiment this list is presented to the user on a web page 201 in their web browser 107 (see FIG. 2). In an alternative embodiment, however, the user simply installs the core modules on his client 103 and the resulting software then offers the user a list of features to be installed. The user's selection then determines which further non-core modules will be received and installed.

In a further embodiment a mixture of both approaches could be implemented. That is, some features could be selected in the web browser 201 whilst additional features could be selected using the core modules that have already been received.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. Accordingly, the foregoing description is intended for purposes of illustration and not of limitation.

1. A method of delivering software, which comprises:
a) presenting a software feature selection list over a network to a client machine;
b) in response to selection of selected features from said software feature selection list, determining a set of software modules required to perform said selected features, said set of software modules including a subset of core modules and a subset of non-core modules, at least some of the modules of said set of software modules including module metadata, said module metadata specifying a module identifier, a module type, and a list of prerequisites modules;
c) downloading to said client machine over said network said set of software modules;
d) storing core modules on said client machine in core module storage as said core modules are received;
e) storing non-core modules on said client machine in non-core module storage as said non-core modules are received;
f) determining that said client machine has received said subset of core modules;
g) examining a core module from said core module storage while said client machine continues to receive and store non-core modules;
h) determining if all prerequisite modules for said examined core module have been installed on said client machine;
i) if all said prerequisite modules for said examined core module have been installed on said client machine, installing said examined core module on said client machine;
j) if all said prerequisite modules for said examined core module have not been installed on said client machine, examining another core module in said core module storage;
k) repeating g)-j) until all said core modules have been installed on said client machine;
l) examining a non-core module from said non-core module storage;
m) determining if all prerequisite modules for said examined non-core module have been installed on said client machine;
n) if all said prerequisite modules for said examined non-core module have been installed on said client machine, installing said examined non-core module on said client machine;
o) if all said prerequisite modules for said examined non-core module have not been installed on said client machine, examining another non-core module in said non-core module storage;
p) repeating l)-o) until all said non-core modules have been installed on said client machine.
